(19) United States
(12) Patent Application Publication
(10) Pub. No.: US 2022/0145963 A1
(43) Pub. Date: May 12, 2022

(54) PLATE LINK CHAIN HAVING SURFACE STRUCTURE AND METHOD FOR SECURING POSITIONS

(71) Applicant: Schaeffler Technologies AG & Co. KG, Herzogenaurach (DE)

(72) Inventors: Marius Wohlschlegel, Rastatt (DE); Dominik Störkle, Karlsruhe (DE)

(73) Assignee: Schaeffler Technologies AG & Co. KG, Herzogenaurach (DE)

(21) Appl. No.: 17/438,481

(22) PCT Filed: Mar. 20, 2020
(86) PCT No.: PCT/DE2020/100225

§ 371 Date: Sep. 13, 2021

(30) Foreign Application Priority Data
Apr. 18, 2019 (DE) 10 2019 110 227.8

(51) Int. Cl. F16G 5/18

(52) U.S. Cl. CPC F16G 5/18

(57) ABSTRACT

A plate link chain for a continuously variable transmission of a motor vehicle includes a plurality of plates with respective openings, and a pressure piece inserted into the respective openings to hingedly connect the plurality of plates to each other. The pressure piece includes an end portion protruding from a one of the plates on one side of the plate link chain and a securing element integrally bonded on the end portion for securing a position of the pressure piece relative to the one of the plates. The end portion has a first fastening surface and the securing element has a second fastening surface for fastening to the first fastening surface. The first fastening surface or the second fastening surface has a purposefully introduced surface structure. The purposefully introduced surface structure may be introduced by means of material removal, material application or material deformation, for example.

### CROSS-REFERENCE TO RELATED APPLICATIONS

This application is the United States National Phase of PCT Appln. No. PCT/DE2020/100225 filed Mar. 20, 2020, which claims priority to German Application No. DE102019110227.8 filed Apr. 18, 2019, the entire disclosures of which are incorporated by reference herein.

### TECHNICAL FIELD

The present disclosure relates to a plate link chain/CVT chain for a continuously variable transmission of a motor vehicle, having plates which are, for example, arranged parallel to a running direction of the plate link chain, which have openings into which at least one (cradle) pressure piece, for example oriented transversely to the running direction, is inserted such that the at least one pressure piece hingedly connects at least two plates to each other. The pressure piece has at least one end portion which protrudes from the plates on one (longitudinal) side of the plate link chain and which has a securing element for securing the position of the pressure piece relative to the plates, which securing element is integrally bonded, in particular welded, on the end portion of the pressure piece. The present disclosure furthermore relates to a method for securing the position of a pressure piece relative to at least two plates of such a plate link chain/CVT chain.

### BACKGROUND

Plate link chains with securing elements welded onto the pressure pieces are already known from the prior art. For example, DE 10 2015 202 763 B4 discloses a belt means for a continuously variable transmission of a motor vehicle, which is arranged in the torque flow between a first pair of conical disks and a second pair of conical disks of the transmission, with an assembly of pressure pieces aligned transversely to the running direction of the belt means and plates arranged parallel to the running direction. The pressure pieces engage in openings of the plates, the plates are articulated by means of the pressure pieces, and the pressure pieces protrude from the assembly with their end sections on opposite longitudinal sides of the belt. At least one securing element for securing the plates and/or pressure pieces is connected to at least one of the end sections, and the at least one securing element is formed by an adhesive element.

However, the prior art has the disadvantage that, in a plate link chain for a continuously variable transmission (CVT), which can also be referred to as a CVT chain, securing elements are welded to the (cradle) pressure pieces to secure the position of the plate packs. However, these securing elements can fall off during transport or during operation, which among other things can lead to the plate link chain falling apart, for example during transport.

### SUMMARY

A plate link chain and a method for securing the position of a pressure piece relative to at least two plates of such a plate link chain are disclosed, in which the strength of a weld between the securing element and the pressure piece is increased in order to reduce the probability of a falling safety element. For example, the strength of the welded connection should be increased without intervention or a change in the welding parameters. In addition, dispersion should be reduced.

In a device of the generic type, this is achieved, according to the present disclosure, in that at least one of the surfaces of the securing element and of the pressure piece that are to be fastened to one another has a surface structure that is purposefully introduced. In other words, one of the surfaces of the securing element which are to be fastened to one another and which serves, for example, to prevent the plates and/or the pressure piece from being lost, has a structure.

This has the advantage that the purposeful introduction of the surface structure into the surface of the securing element or the pressure piece to be fastened, e.g., in the surface of the pressure piece to be fastened, results in a larger adhesive surface, which has a positive effect on the strength of the welded connection. Due to the greater roughness, according to the present disclosure, there is thus a larger connecting surface for distributing the force. In addition, that area having the surface structure can be heated uniformly and/or over a wide area, so that the connection area is additionally enlarged.

In an example embodiment, the surface structure can be introduced by means of material removal, material application and/or material deformation. As a result, the surface structure can be provided in a simple and thus inexpensive manner.

The surface structure may be introduced into a convex, i.e., spherical, surface, e.g., of the pressure piece. In the case of spherical surfaces, it is often difficult to form a welded connection with a consistently high strength, so that the surface structure improves the strength of surfaces that are difficult to attach to one another in a beneficial manner.

In addition, the surface structure may at least partially have a defined or regular pattern. In this way, the heat during the welding process can be distributed evenly and in a controlled manner to the surface structure.

According to an example embodiment, the surface structure can be at least partially formed in a formless or irregular manner. As a result, the surface structure can be designed in a simple manner, since no high demands on the surface structure have to be met. It is important that the surface structure changes the roughness of the surface to be fastened, in contrast to when the surface structure is not introduced purposefully. For example, there is an optimum roughness at which the surface can be fastened particularly well, e.g., welded. This means that the surface structure can also have less roughness than the surface without a surface structure.

In an example embodiment, the surface structure can be introduced mechanically and/or chemically. The surface structure may be introduced by grinding, by lasering and/or by embossing, for example. Alternatively, it is also possible if the surface structure is introduced by etching. However, the present disclosure is not restricted to this, and the surface structure can also be produced in another way.

According to an example embodiment, the surface structure can be designed as a hole pattern. A hole pattern can be made in a surface with simple means and with few work steps. A hole pattern is also suitable for curved, e.g., spherical, surfaces.

According to another example embodiment, the surface structure can be designed as a groove pattern. A groove pattern has also proven to be beneficial in terms of manufacturing complexity and in terms of heat distribution.

Furthermore, the surface structure of one of the surfaces to be fastened to one another may be pressed into the other of the surfaces to be fastened to one another in such a way that a receiving structure for the surface structure that is the opposite of the surface structure results. Because one surface is pressed into the other surface, the connection between the two surfaces is resistant to shear forces, so that a firm connection is provided.

The component having the surface structure, i.e., the securing element or the end section of the pressure piece, may have a modified roughness in a region of the surface structure, e.g., optimized for welding, than in a region apart from the region of the surface structure, for example adjacent to the region of the surface structure. This ensures that the roughness is increased by the surface structure.

The present disclosure also includes a method for securing the position of a pressure piece relative to at least two plates of a plate link chain. The pressure piece is inserted into an opening of each of the at least two plates and a securing element is welded onto an end section of the pressure piece. Prior to welding, a surface structure, is purposefully introduced, e.g., mechanically or chemically, for example by grinding, by laser, by embossing or by etching, into at least one of the surfaces to be welded of the pressure piece and the securing element.

In other words, the present disclosure relates to a CVT chain with a securing element welded onto the at least one pressure piece, and the welded connection is arranged on a structured surface. For this purpose, one of the surfaces to be welded to one another is provided with a structure that can be created, for example, by applying, removing or deforming material. This structuring can either be formless or random or defined, for example as a pattern. The structuring can be produced mechanically, chemically or in some other way.

### BRIEF DESCRIPTION OF THE DRAWINGS

The present disclosure is explained below with the aid of drawings. In the figures:

FIG. 1 shows a perspective illustration of a section of a plate link chain according to the present disclosure, in which a surface structuring of a pressure piece is shown in a first embodiment,

FIG. 2 shows a perspective illustration of a second embodiment of the surface structuring,

FIG. 3 shows a perspective illustration of a third embodiment of the surface structuring,

FIG. 4 shows a perspective illustration of a fourth embodiment of the surface structuring,

FIG. 5 shows a perspective illustration of a fifth embodiment of the surface structuring,

FIG. 6 shows a perspective illustration of a sixth embodiment of the surface structuring,

FIG. 7 shows a perspective illustration of a seventh embodiment of the surface structuring,

FIG. 8 shows a perspective illustration of an eighth embodiment of the surface structuring,

FIGS. 9 to 11 show perspective illustrations showing a securing element that is welded onto the surface structure,

FIG. 12 shows a schematic illustration of a continuously variable transmission with the plate link chain, and

FIG. 13 shows a perspective illustration of the plate link chain.

### DETAILED DESCRIPTION

The figures are only schematic in nature and serve exclusively for understanding the disclosure. The same elements are provided with the same reference symbols. The features of the exemplary embodiments can be interchanged.

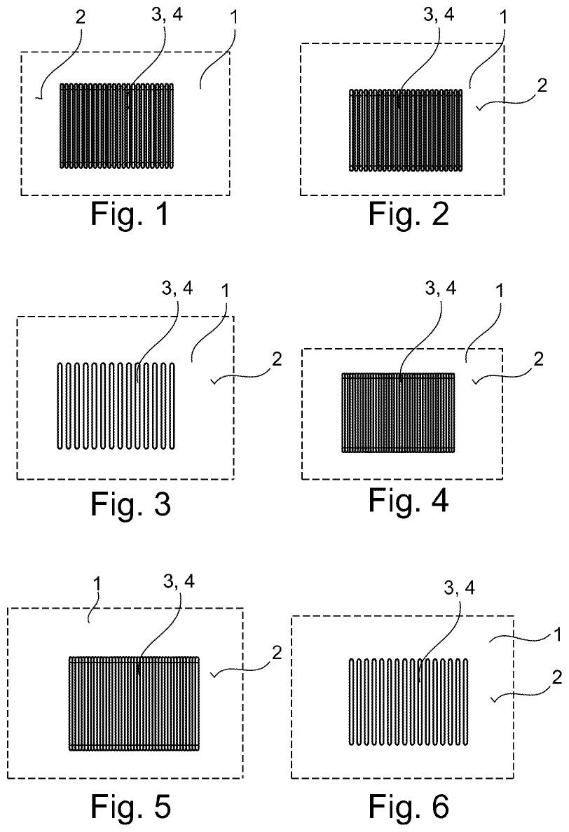

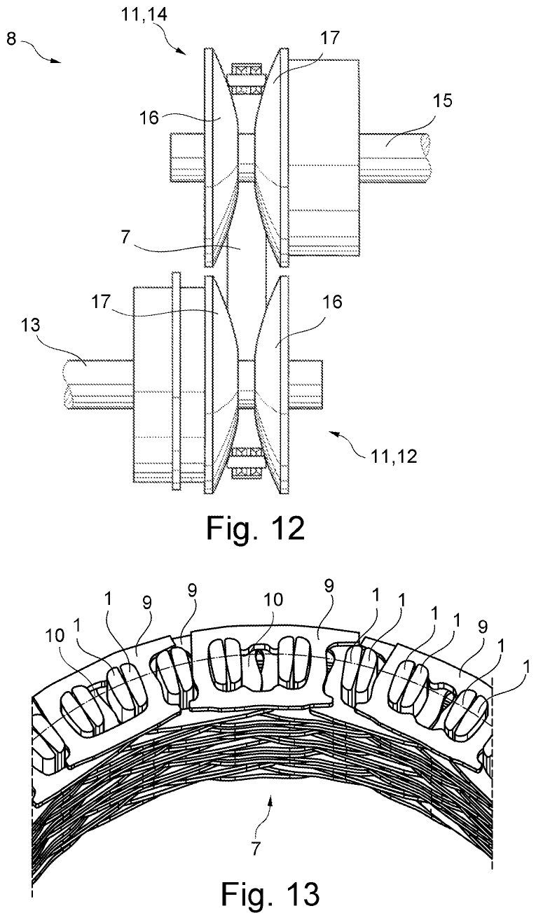

FIG. 1 shows a section of a plate link chain 7 (ref. FIG. 12), according to the disclosure, for a continuously variable transmission 8 of a motor vehicle. The plate link chain 7 has plates 9 (ref. FIG. 13) with openings 10, into which at least one pressure piece 1 is inserted in such a way that the at least one pressure piece 1 connects at least two plates 9 to one another in an articulated manner. The continuously variable transmission 8 and the plate link chain 7 will be described in more detail later with reference to FIGS. 12 and 13.

In FIGS. 1 to 7, a section of the pressure piece 1, e.g., an end section of the pressure piece 1, is shown. The end section of the pressure piece 1 protrudes from the plates 9 on one side of the plate link chain 7 in an assembled state of the plate link chain 7. The pressure piece 1 has securing element 6 (ref. FIGS. 9 to 11), not shown in FIGS. 1 to 7, for securing the position of the pressure piece 1 relative to the plates 9. The securing element 6 is materially connected to the end section of the pressure piece 1. According to the disclosure, at least one of the surfaces 2 of the securing element and of the pressure piece 1 that are to be fastened to one another has a surface structure 3 which has been purposefully introduced.

FIG. 1 shows a section of the pressure piece 1. The pressure piece 1 has the surface 2. The surface 2 is formed spherical, i.e., convex. A surface of the securing element 6 (see FIGS. 9 to 11) is fastened to the surface 2. In particular, the securing element 6 is fastened to the surface 2 by welding.

The surface 2 has the surface structure 3. In the first embodiment, the surface structure 3 is designed as a groove pattern 4. The groove pattern 4 has multiple grooves which are evenly spaced apart. The grooves protrude from the surface 2. The surface structure 3 has a rectangular outer contour.

FIGS. 1 to 6 show different embodiments of the surface structure 3. The surface structure 3 is designed as the groove pattern 4 in each case. The grooves of the surface structure 3 of the various embodiments differ in their groove width, in their spacing and/or in their number. Due to the groove pattern 4, the surface 2 has a greater roughness in the area of the surface structure 3 than in an area of the surface 2 in which the surface structure 3 is not formed.

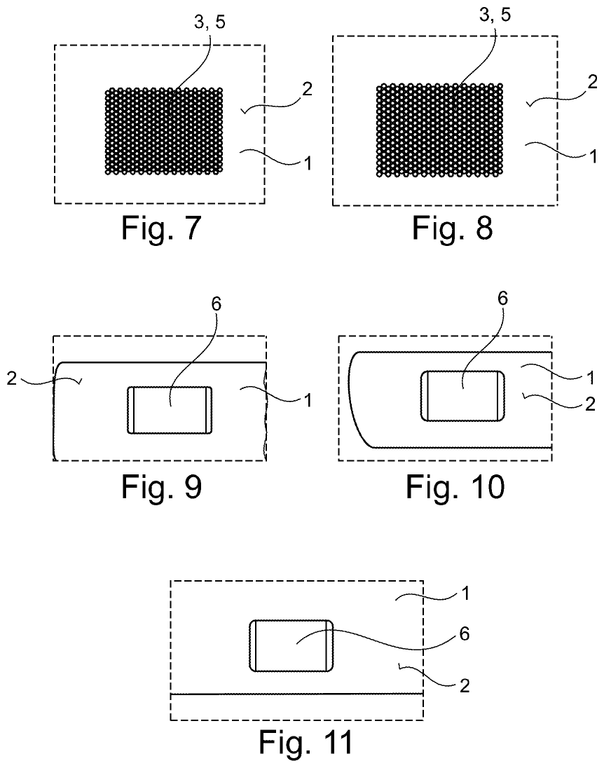

FIGS. 7 and 8 show different embodiments of the surface structure 3. The surface structure 3 is designed as a hole pattern 5 in each case. The hole pattern 5 has multiple holes, which are spaced apart from one another at regular intervals. A grid-like structure formed by the holes protrudes from the surface 2. The surface structure 3 has a rectangular outer contour. The outer contour can also have any other outer contour. The decisive factor here is that the shape of the outer contour is at least as large as the area to be welded onto it, in this case the surface of the securing element 6. The surface structure 3 of the various embodiments differs in the size of the holes and/or in the number of holes. Due to the hole pattern 5, the surface 2 has a greater roughness in the area of the surface structure 3 than in an area of the surface 2 in which the surface structure 3 is not Ruined.

Alternatively, a surface of the securing element 6 on which the securing element is welded to the pressure piece 1 can also have a surface structure, even if this is not explicitly shown in the figures.

The surface structure 3 can also be designed in a formless or random manner, i.e., without a regular pattern, even though this is not explicitly shown in the figures.

FIGS. 9 to 11 show the pressure piece 1, on the surface 2 of which in the area of the surface structure 3 the securing element 6 is welded. The securing element 6 protrudes from the convex surface 2. The pressure piece 1 can, for example, have an essentially oval cross section, and the securing element 6 is arranged on a rounded portion of the pressure piece 1 which has a smaller radius. The surface structure 3 can also be present on a concave or on a flat/straight surface, even if this is not shown.

FIG. 12 shows a schematic representation of the continuously variable transmission 8, in which the plate link chain 8 serves as a belt means/traction means. The transmission 8 has two pairs of conical disks 11. A first pair of conical disks 12 of the two pairs of conical disks 11 is connected to a drive shaft 13. A second pair of conical disks 14 of the two pairs of conical disks 11 is connected to an output shaft 15. Each pair of conical disks 11 has a conical disk 16 fixed with it, which is firmly connected to the drive shaft 13 or to the output shaft 15, and a movable conical disk 17, which can be axially guided and displaced in a controlled manner on the drive shaft 13 or the output shaft 15. Diagonally opposite conical disks 16, 17 of the two pairs of conical disks 11 are fixed or movable. As a result, the pairs of conical disks 11 move in opposite directions, so that the plate link chain 7 remains pretensioned while the traction element length of the plate link chain 7 remains the same and the center distance between the drive shaft 13 and the output shaft 15 remains the same.

A small traction means radius in the first (drive) pair of conical disks 12 corresponds to a small gear of a conventional transmission; a large radius corresponds to a large gear. When the conical disks 16, 17 of the pairs of conical disks 11 are far apart, the plate link chain 8 describes a small radius on the conical surface. When the conical disks 16, 17 of the pairs of conical disks 11 are close to one another, the plate link chain 8 describes a large radius on the conical surface. Thus, the gear ratio becomes larger when the conical disks 16, 17 are compressed, and smaller when the conical disks 16, 17 are removed from one another.

FIG. 13 shows the plate link chain 7. The plate link chain 7 has a multiplicity of plates 9 which extend parallel to a running direction of the plate link chain 7. The plates 9 are arranged in multiple rows which are arranged next to one another with respect to the running direction of the link plate chain 7. The plates 9 each have an opening 10 into which a (cradle) pressure piece pair is inserted in such a way that the (cradle) pressure piece pair connects two plates 9 to one another in an articulated manner. A pair of pressure pieces penetrates the plates 9 transversely to the running direction of the link plate chain 7. Each plate 9 is penetrated by two pairs of pressure pieces in order to be connected to a plate 9 which is arranged in an adjacent row in the running direction in front of the plate 9, and to a plate 9 which is arranged in an adjacent row in the running direction behind the plate 9. The pressure pieces 1 extend through the openings 10 of the plates 9 over the entire width of the link plate chain 7. The end sections of the pressure pieces 1 therefore protrude from the plates 9 on the side of the plate link chain 7. In order to prevent the pressure pieces 1 from falling out of the plate link chain 7, the securing elements 6 described above, which are not shown in FIG. 13, are provided.

### REFERENCE NUMERALS

1 Pressure piece
2 Surface
3 Surface structure
4 Groove pattern
5 Hole pattern
6 Securing element
7 Plate link chain
8 Continuously variable transmission
9 Plate
10 Opening

1.-10. (canceled)

11. A plate link chain for a continuously variable transmission of a motor vehicle, comprising:
a plurality of plates comprising respective openings;
a pressure piece inserted into the respective openings to hingedly connect the plurality of plates to each other, the pressure piece comprising:
an end portion protruding from a one of the plates on one side of the plate link chain, the end portion comprising a first fastening surface; and
a securing element integrally bonded on the end portion for securing a position of the pressure piece relative to the one of the plates, the securing element comprising a second fastening surface for fastening to the first fastening surface, wherein the first fastening surface or the second fastening surface comprises a purposefully introduced surface structure.

12. The plate link chain of claim 11, wherein the purposefully introduced surface structure is introduced by means of material removal, material application or material deformation.

13. The plate link chain of claim 11, wherein at least a portion of the purposefully introduced surface structure has a defined or a regular pattern.

14. The plate link chain of claim 11, wherein at least a portion of the purposefully introduced surface structure is at least partially shapeless or irregular.

15. The plate link chain of claim 11, wherein the purposefully introduced surface structure is introduced mechanically or chemically.

16. The plate link chain of claim 11, wherein the purposefully introduced surface structure is designed as a hole pattern.

17. The plate link chain of claim 11, wherein the purposefully introduced surface structure is designed as a groove pattern.

18. The plate link chain of claim 11, wherein:
the first fastening surface comprises the purposefully introduced surface structure and the second fastening surface is pressed into the first fastening surface in such a way that a receiving structure is produced that is the opposite of the purposefully introduced surface structure; or
the second fastening surface comprises the purposefully introduced surface structure and the first fastening surface is pressed into the second fastening surface in such a way that a receiving structure is produced that is the opposite of the purposefully introduced surface structure.

19. The plate link chain of claim 11, wherein:
the first fastening surface comprises the purposefully introduced surface structure and the first fastening surface has a greater roughness in an area of the purposefully introduced surface structure than in a region apart from the purposefully introduced surface structure; or
the second fastening surface comprises the purposefully introduced surface structure and the second fastening surface has a greater roughness in an area of the purposefully introduced surface structure than in a region apart from the purposefully introduced surface structure.

20. A method for securing a position of the pressure piece relative to the plurality of plates of the plate link chain of claim 11, comprising:
inserting the pressure piece into the respective openings;
purposefully introducing the purposefully introduced surface structure to the first fastening surface or the second fastening surface; and
welding the second fastening surface to the first fastening surface to secure the securing element to the end portion.
